(19) United States
(12) Patent Application Publication
(10) Pub. No.: US 2012/0035022 A1
(43) Pub. Date: Feb. 9, 2012

(54) EXERCISE MACHINE

(76) Inventor: Ying-Chou Lai, Huatan Township (TW)

(21) Appl. No.: 12/852,510

(22) Filed: Aug. 8, 2010

(51) Int. Cl. A63B 22/04; F16H 21/32

(52) U.S. Cl. 482/52; 74/40

(57) ABSTRACT

An exercise machine comprises an oval-shaped structure, two driving arms, two swing handle and two slidable bars. The fly wheel of the oval-shaped mechanism simultaneously drives the driving arms and the swing handle, and the slidable bars are pivoted onto the assembling portion of the swing handle and rest on the shaft of the fly wheel such that the movements of the slidable bars are not limited by the driving arms and longer the travel stroke of the fly wheel.

### BACKGROUND OF THE INVENTION

1. Field of the Invention

The present invention relates to an exercise machine having an oval-shaped mechanism, and more particularly to an oval-shaped mechanism having driving arms, which can provide a longer and various stroke with respect to the fly wheel.

2. Description of the Related Art

Currently, a prior art exercise machine, as shown in FIG. 11, comprises: an oval-shaped structure 50, two swing handles 60 and two slidable bars 70. The oval-shaped structure 50 comprises a base 51 having a fly wheel 52 and a standing rod 53 attached to a front end of the oval-shaped structure 50. The fly wheel 52 has a shaft 521 extending from two sides of the flywheel and a pivoting shaft 531 extends from two sides of the standing rod 53. The two swing handles 60 respectively have a gripping portion 61, a linking arm 62 and a connecting tube 63 jacketed onto the pivoting shaft 531 of the standing rod 53. The linking arm 62 has an assembly portion 64 at an opposite end of the gripping portion 61. The slidable bars 70 each have a first pivoting portion 71 for attachment onto the assembly portion 64 of the respective swing handle 60, a second pivoting portion 72 with a ring for jacketing onto the shaft 521 of the fly wheel 52, and a pedal 73 disposed on a predetermined position of each slidable bar 70. When user wants to operate the exercise machine, he or she needs to stand on both of the pedals 73 of the slidable bars 70 and hold both of the swing handles 60, by swinging both arms and stepping both legs, the fly wheel 52 provides continuous movement and identical travel strokes for the swing handles 60 and the slidable bars 70.

However, the prior art exercise machine has following drawback: since second pivoting portion 72 with a ring is directly jacketed onto the shaft 521 of the fly wheel 52 and the first pivoting portion 71 is attached onto the assembling portion 64 of the swing handle 60, the oval-shaped structure 50 has a travel stroke limited by the fly wheel 52 such that slidable bars 70 and the swing handles 60 have the same travel stroke as the fly wheel 52.

Therefore, it is desirable to provide an exercise machine to mitigate and/or obviate the aforementioned problems.

### SUMMARY OF THE INVENTION

An objective of the present invention is to provide an exercise machine having driving arms, which can provide a longer and variously adjustable stroke with respect to the fly wheel.

In order to achieve the above-mentioned objectives, an oval-shaped structure comprises a base having a fly wheel, the fly wheel having a shaft eccentrically extending from two sides, the shaft jacketed with a sleeve, a standing rod attached to a front end of the oval-shaped structure, and a pivoting shaft extending from two sides of the standing rod; two driving arms respectively attached to two sides of the oval-shaped structure, one end having a securing portion and another end having a first pivoting portion with a ring for jacketing onto the shaft of the fly wheel; two swing handles respectively having a gripping portion and a linking arm at two ends; a connecting tube disposed between the gripping portion and the linking arm and pivoted onto the pivoting shaft of the standing rod, at least one positioning shaft disposed on the linking arm for securing the securing portion of the driving arms; and an assembling portion at an end away from gripping portion; and two slidable bars respectively having a second pivoting portion for attaching onto the assembling portion of the swing handle, and a pedal disposed at a predetermined position of each slidable bar.

With the above-mention structure, the following benefits can be obtained: the fly wheel of the oval-shaped structure provides linkage movements to the driving arms and the swing handle, the slidable bar utilizes the second pivoting portion for attachment onto the assembling portion of the swing handle and rests on the shaft of the fly wheel, such that the sliding movements of the slidable bars are not limited by the driving arms and may be longer than the travel stroke of the fly wheel. Therefore, the oval-shaped structure is capable of providing different exercise effects for the users

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is a side view illustrating operation of an embodiment of the present invention.

FIG. 4 is a side view illustrating continuous movement of an embodiment of the present invention.

FIG. 5 is another side view illustrating continuous movement of an embodiment of the present invention.

FIG. 6 is another side view illustrating continuous movement an embodiment of the present invention.

FIG. 7 is a local detailed view of a first embodiment of the present invention.

FIG. 8 is a local detailed view of a second embodiment of the present invention.

FIG. 9 is a local detailed view of a third embodiment of the present invention.

FIG. 10 is a local detailed view of a fourth embodiment of the present invention

FIG. 11 is a perspective view of a prior art device.

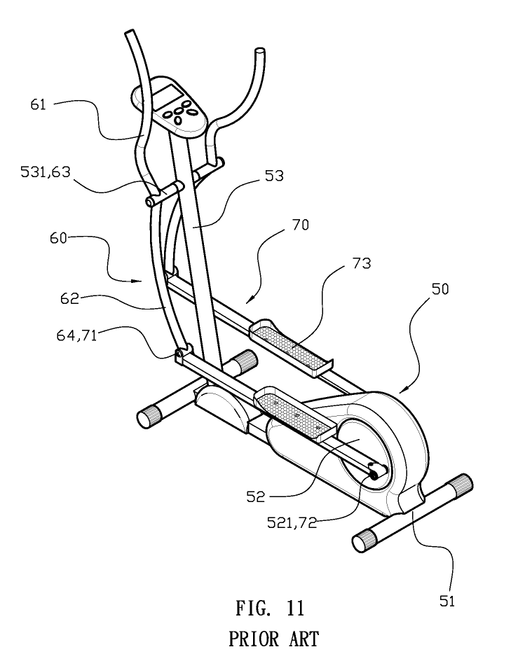

### DETAILED DESCRIPTION OF THE PREFERRED EMBODIMENT

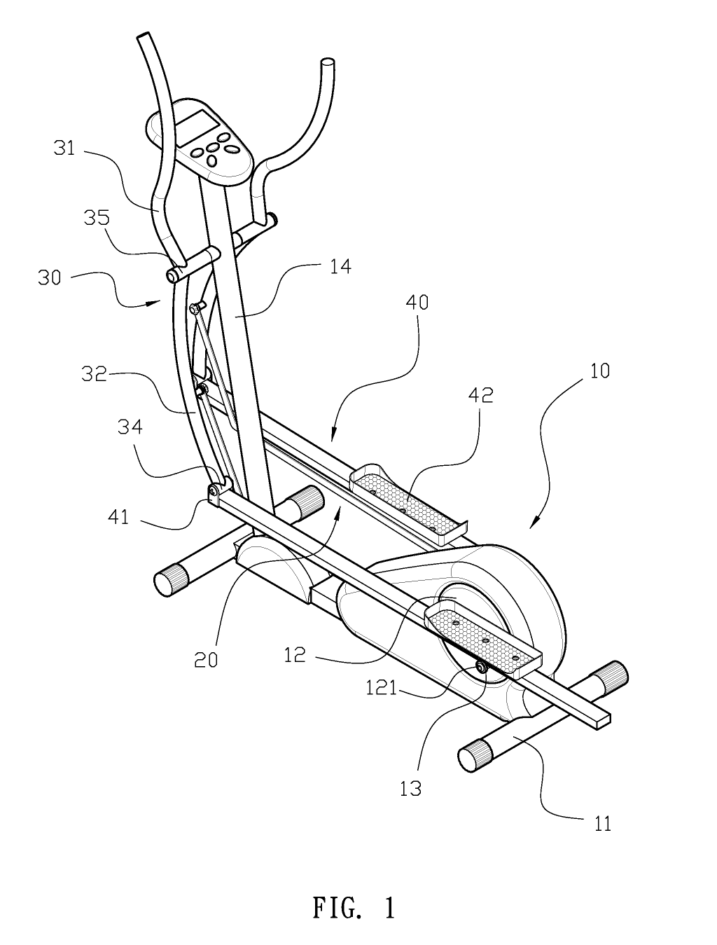

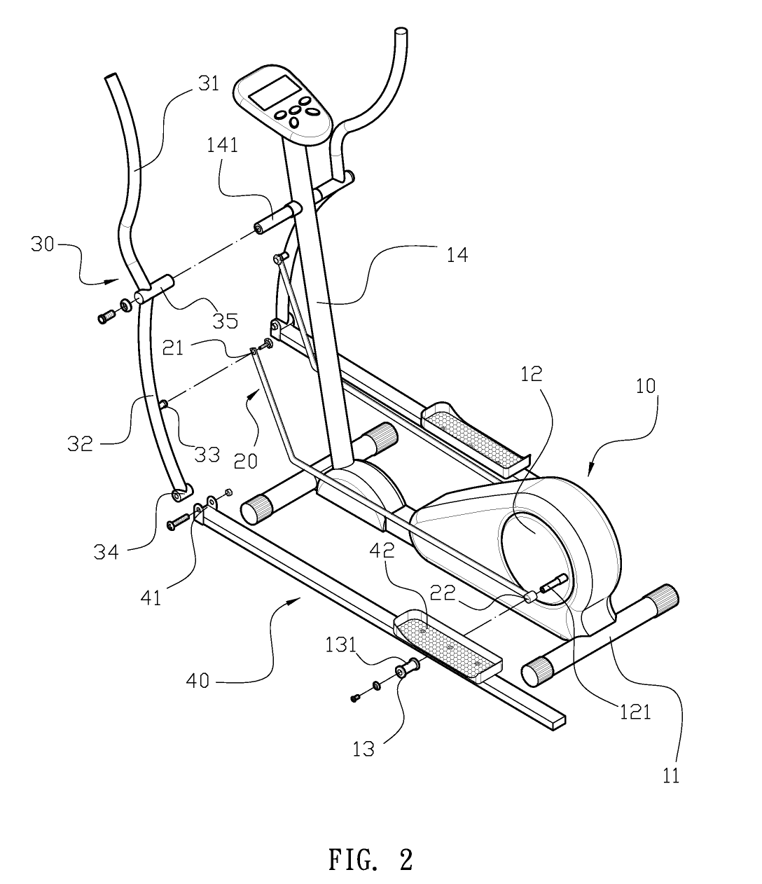

Please refer to FIG. 1 and FIG. 2. An exercise machine comprises an oval-shaped structure 10, two driving arms 20, two swing handles 30 and two slidable bars 40. The oval-shaped structure 10 comprises a base 11 having a fly wheel 12. The fly wheel 12 has a shaft 121 eccentrically extending from two opposing sides; the shaft 121 is jacketed with a sleeve 13, and a limiting track 131 is formed between the peripheries of the sleeve 13 and used for securing the slidable bar 40. Furthermore, a standing rod 14 is attached to a front end of the oval-shaped structure 10, and a pivoting shaft 141 extends from two opposing sides of the standing rod 14. The pivoting shaft 141 has a threaded aperture and corresponding screws. The two driving arms 20 are respectively attached to the two sides of the oval-shaped structure 10, and one end of each has a securing portion 21 and another end has a first pivoting portion 22 with a ring for jacketing onto the shaft 121 of the fly wheel 12. Moreover, each driving arm forms an obtuse angle. The two swing handles 30 each have a gripping portion 31 and a linking arm 32 at two respectively ends; a connecting tube 35 is disposed between the gripping portion 31 and the linking arm 32, and at least one positioning shaft 33 is disposed on each linking arm 32 for securing the securing portion 21 of the respective driving arm 20. Each swing handle 30 also has an assembling portion 34 at an end opposite the gripping portion 32. The two slidable bars 40 are a long boards that are narrower than the limiting track 131 of the sleeve 13 and each respectively has a second pivoting portion 41 for attaching onto the assembling portion 34 of the swing handle 30 and a pedal 42 disposed at a predetermined position of each slidable bar 40.

For assembly, please refer to FIG. 1 and FIG. 2. The two driving arms 20 are each attached to two respective sides of the oval-shaped structure 10, and the pivoting portions 22 are jacketed onto the shaft 121 of the fly wheel 12, and each shaft 121 utilizes the corresponding sleeve 13 for securing of the pivoting portion 22. The two swing handles 30 are also each coupled to two respective sides of the oval-shaped structure 10 and utilize the connecting tubes 35 for jacketing onto the two respective pivoting shafts 141 on two respective sides of the standing rod 14 and are then secured by screws. Each linking arm 32 utilizes the positioning shaft 33 for mounting of the securing portion 21 of a respective driving arm 20. The two slidable bars 40 are also each attached to two respective sides of the oval-shaped structure 10, respectively utilizing the second pivoting portion 41 for pivoting onto the assembling portion 34 of the respective swing handle 30, and are each placed in the respective limiting track 131 of the sleeve 13.

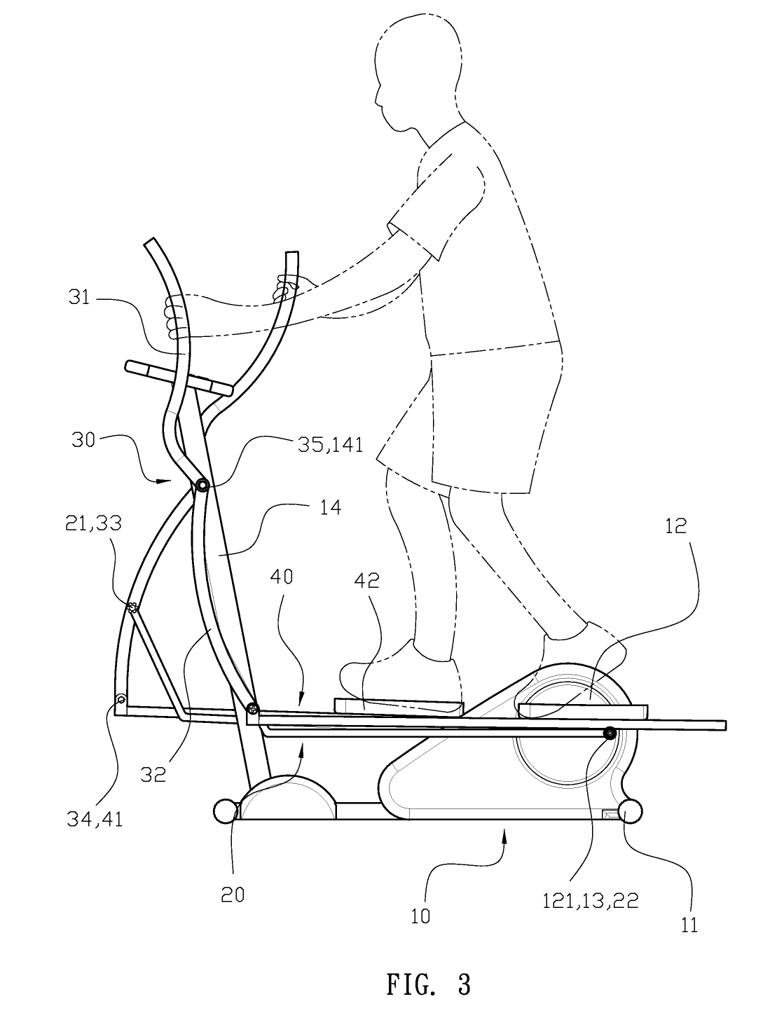

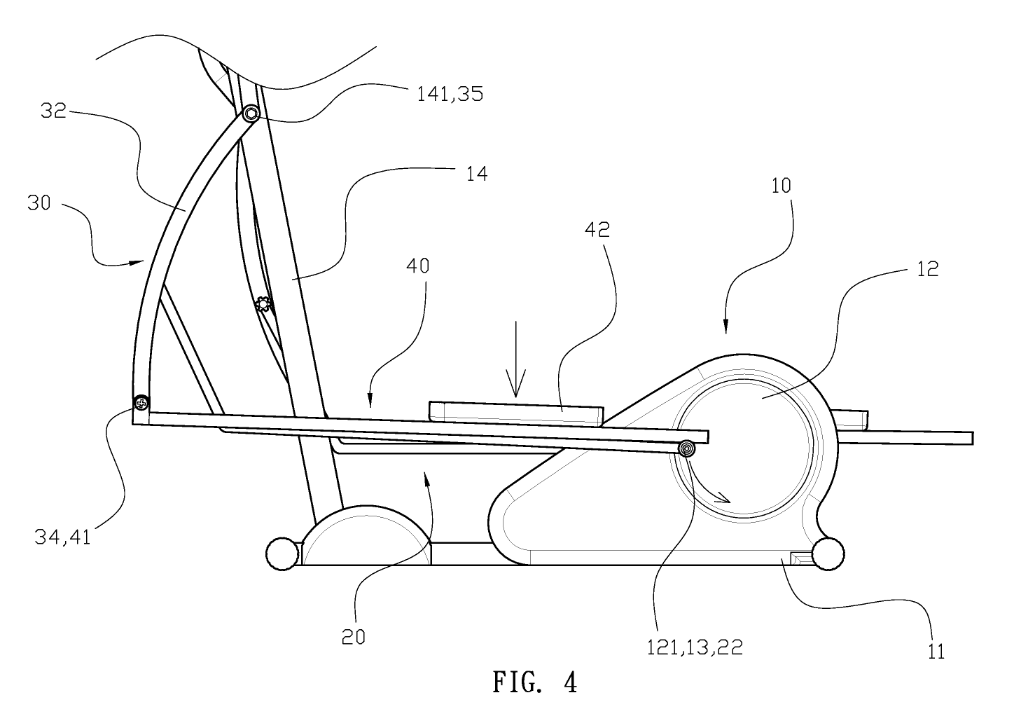

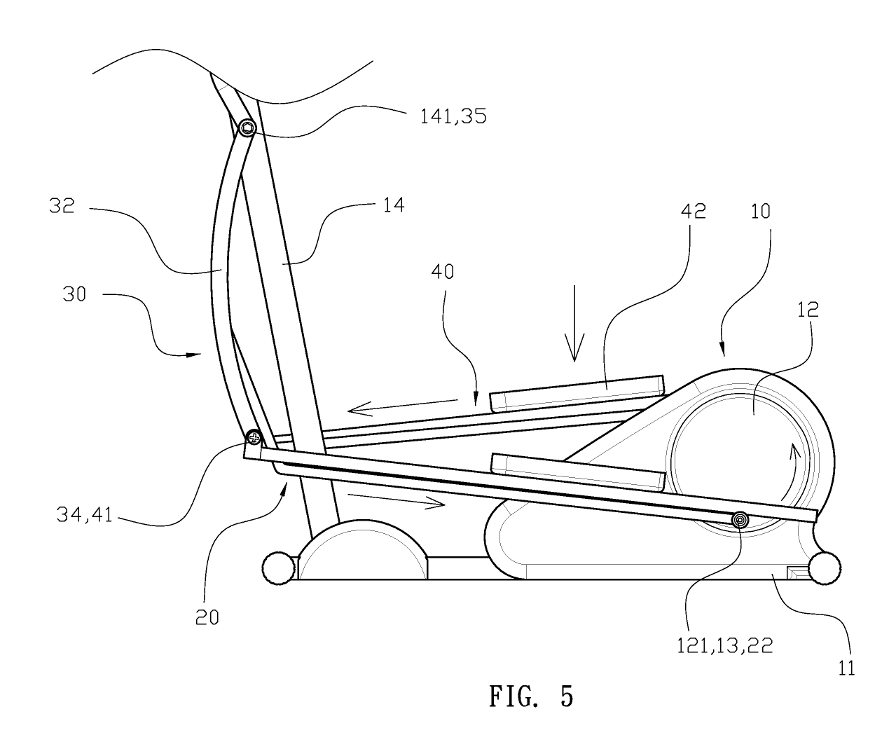

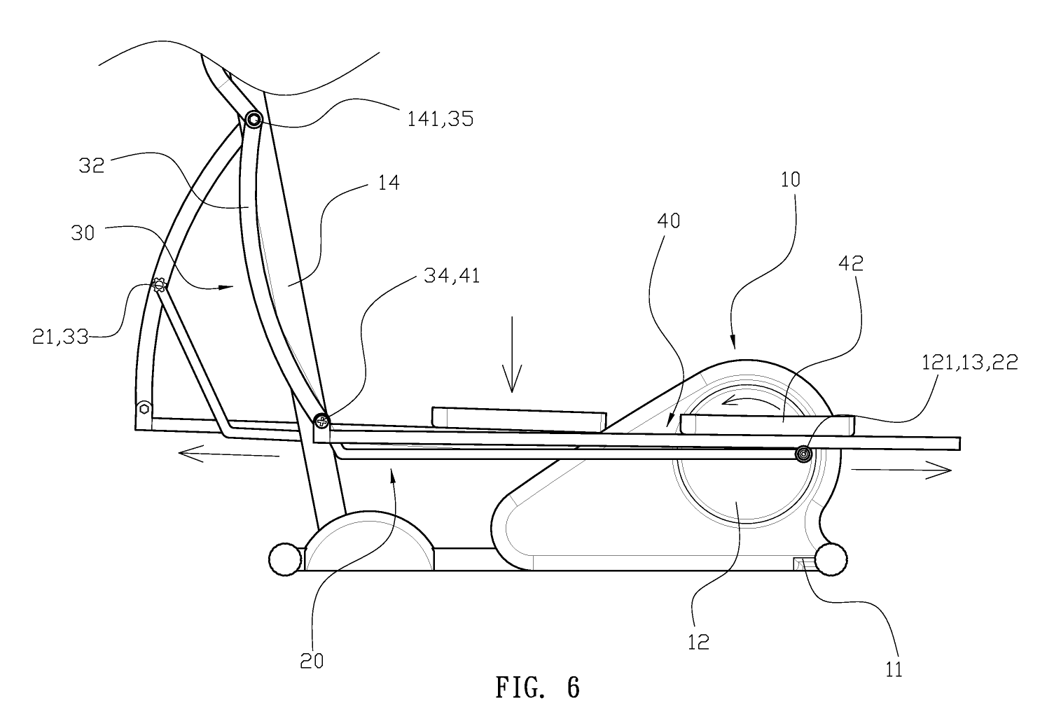

For operations, please refer to FIG. 3 together with FIGS. 4-6. A user stands on both of the pedals 43 of the slidable bars 40 and holds both of the gripping portions 31 of the swing handles 30; the user then swings both arms and employs a stepping motion with both legs. The pivoting portion 22 of the driving arms 20 are jacketed onto the shaft 121 of the fly wheel 12, and the securing portion 21 is mounted onto the positioning shaft 33 of the swing handle 30, such that each driving arm 20 is connected to both the fly wheel 12 and the respective swing handle 30. The slidable bars 40 utilize the second pivoting portion 41 for attaching onto the assembling portion 34 of the swing handle 30, such that the slidable bars 40 and driving arms 20 utilize different pivoting points for swinging movements and both overlap each other to rest on the sleeve 13 of the shaft 121 of the flywheel 12; therefore, when the user steps with both feet and swings with both hands, with the free joints formed by the second pivoting portions 41 of the slidable bars 40 and the assembling portion 34 of the swing handle 30, the movements of the slidable bars 40 are not limited by the sleeve 13 of the shaft 121, such that the swing handles 30 and the slidable bars 40 are capable of having travel strokes that are longer than the travel stroke of the fly wheel 12.

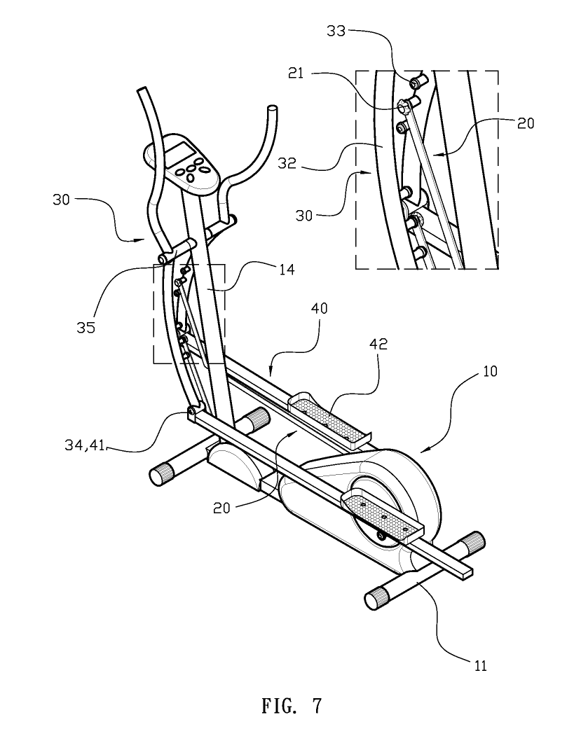

For a second embodiment of the exercise machine, please refer to FIG. 7. A plurality of positioning shafts 33 are disposed on a side of the linking arm 32 of each swing handle 30 such that the securing portion 21 of the respective driving arm 20 is adjustable for connection to any of the positioning shafts 33 of the linking arm 30.

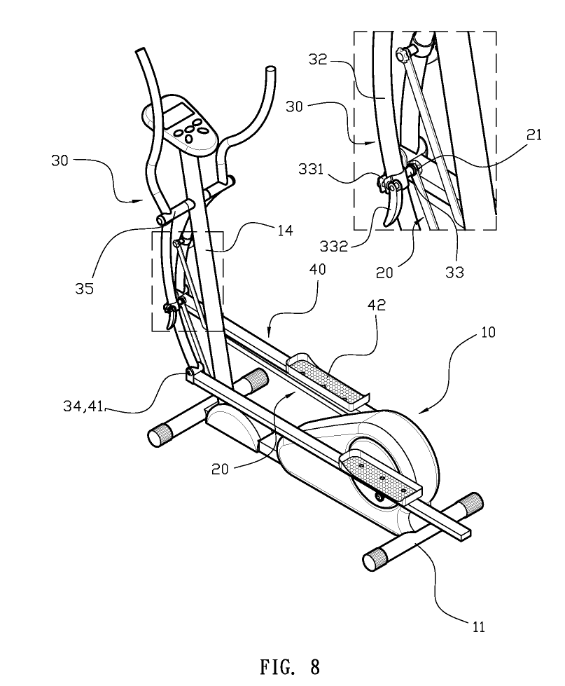

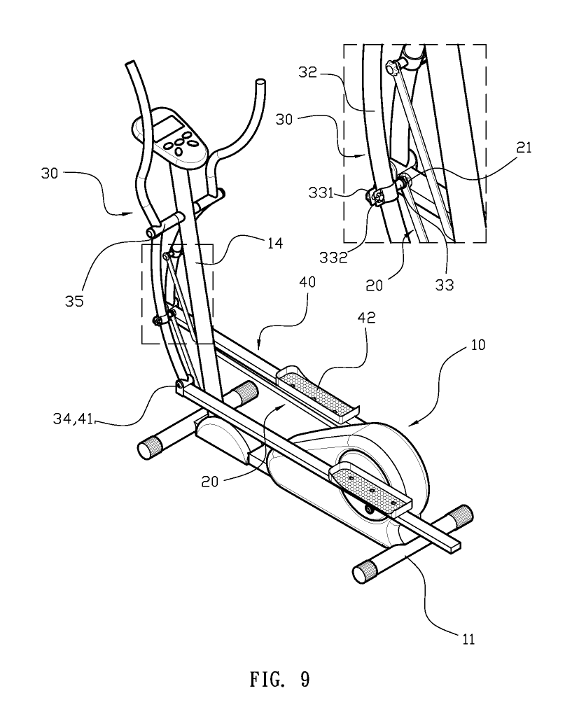

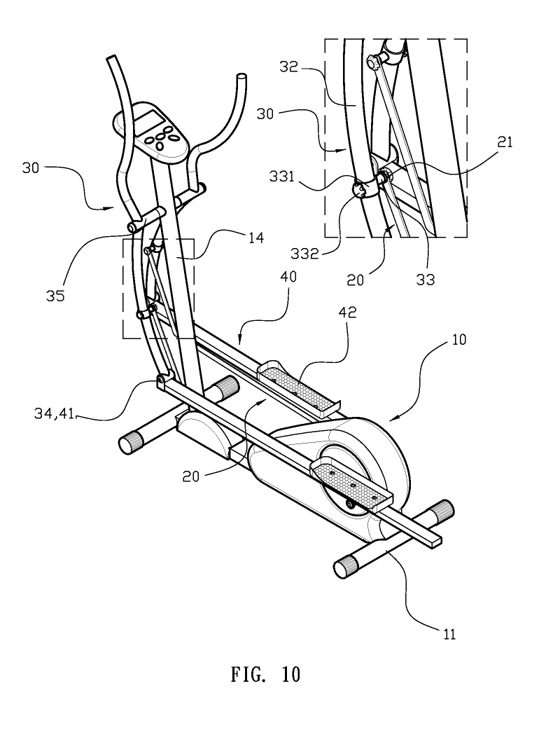

For others embodiments of the exercise machine, please refer to FIGS. 8, 9, and 10. A moveable securing member 331 and a corresponding positioning member 332 are attached onto each linking arm 32, and a positioning shaft 33 is disposed on the linking arm 32 for securing the securing portion 21 of the respective driving arm 20, such that the positioning shaft 33 can be moved along the linking arm 32 with the securing member 331, and be attached to the securing portion 21 of the driving arms 20 and secured into place by the positioning member 332. Therefore, the travel distance of the linking arm 32 can be changed. The positioning member 332 can be a quick-release member, a locking member or a tightening member.

With the above-mentioned structure the following benefits can be obtained: the fly wheel 12 of the oval-shaped structure 10 provides linkage movements to the driving arms 20 and the swing handles 30, the slidable bars 40 utilize the second pivoting portions 41 for attachment onto the assembling portions 34 of the swing handles 30 and rest on the shaft 121 of the fly wheel 12, such that the sliding movements of the slidable bars 40 are not limited by the driving arms 20 and may be longer than the travel stroke of the fly wheel 12. Therefore, the oval-shaped structure 10 is capable of providing different exercise effects to the users.

Although the present invention has been explained in relation to its preferred embodiment, it is to be understood that many other possible modifications and variations can be made without departing from the spirit and scope of the invention as hereinafter claimed.

What is claimed is:

1. An exercise machine comprising:
an oval-shaped structure comprising a base having a fly wheel, the fly wheel having a shaft eccentrically extending from two sides, the shaft jacketed with a sleeve, a standing rod attached to a front end of the oval-shaped structure, and a pivoting shaft extending from two sides of the standing rod;
two driving arms respectively attached to two sides of the oval-shaped structure, one end having a securing portion and another end having a first pivoting portion with a ring for jacketing onto the shaft of the fly wheel;
two swing handles having a gripping portion and a linking arm at two respectively ends; a connecting tube disposed between the gripping portion and the linking arm and pivoted onto the pivoting shaft of the standing rod, at least one positioning shaft disposed on the linking arm for securing the securing portion of the driving arms; and an assembling portion at an end opposite from gripping portion; and
two slidable bars respectively having a second pivoting portion for attaching onto the assembling portion of the respective swing handle, and a pedal disposed at a predetermined position on each slidable bar.

2. The exercise machine as claimed in claim 1, wherein a plurality of positioning shafts are disposed on a side of the linking arm such that the securing portion of the respective driving arm is adjustable for connection to any of the positioning shafts of the linking arm.

3. The exercise machine as claimed in claim 1, wherein a limiting track is formed within the peripheries of the sleeve for securing the slidable bar.

4. The exercise machine as claimed in claim 1, wherein the pivoting shaft has a threaded aperture and corresponding screws.

5. The exercise machine as claimed in claim 1, wherein the driving arm forms an obtuse angle.

6. An oval-shaped mechanism comprising:
a base having a fly wheel, the fly wheel having a shaft eccentrically extending from two sides, the shaft jacketed with a sleeve, a standing rod attached to a front end of the oval-shaped mechanism, and a pivoting shaft extending from two sides of the standing rod;
two driving arms respectively attached to two sides of the oval-shaped mechanism, one end having a securing portion and another end having a first pivoting portion with a ring for jacketing onto the shaft of the fly wheel;
two swing handles respectively having a gripping portion and a linking arm; a connecting tube disposed between the gripping portion and the linking arm and pivoted onto the pivoting shaft of the standing rod; a moveable securing member and a corresponding positioning member attached onto the linking arm, a positioning shaft disposed on the linking arm for securing the securing portion of the driving arms; and an assembling portion at an end opposite the gripping portion; and
two slidable bars having a second pivoting portion for attaching onto the assembling portion of the swing handle, and a pedal disposed at a predetermined position on each slidable bar.

7. The oval-shaped mechanism as claimed in claim 6, wherein the positioning member is a quick-release member capable of locking onto the securing member at any position of the linking arm of the swing handle.

8. The oval-shaped mechanism as claimed in claim 6, wherein the positioning member is a locking member capable of locking the securing member onto any position of the linking arm of the swing handle.

9. The oval-shaped mechanism as claimed in claim 6, wherein the positioning member is a tightening member capable of locking onto the securing member at any position of the linking arm of the swing handle.

10. The oval-shaped mechanism as claimed in claim 6, wherein a limiting track is formed between the peripheries of the sleeve for securing the slidable bar.

11. The oval-shaped mechanism as claimed in claim 6, wherein the pivoting shaft has a threaded aperture and corresponding screws.

12. The oval-shaped mechanism as claimed in claim 6, wherein the driving arm forms an obtuse angle.
